(19) United States
(12) Patent Application Publication
(10) Pub. No.: US 2026/0170083 A1
(43) Pub. Date: Jun. 18, 2026

(54) SYSTEMS AND METHODS FOR ARTIFICIAL INTELLIGENCE COMPUTATIONS

(71) Applicant: Samsung Electronics Co., Ltd., Suwon-si (KR)

(72) Inventors: Marie Mai Nguyen, Pittsburgh, PA (US); Usman Sajid, San Jose, CA (US); Rekha Pitchumani, Oak Hill, VA (US); Yang Seok Ki, Palo Alto, CA (US)

(21) Appl. No.: 19/422,945

(22) Filed: Dec. 17, 2025

Related U.S. Application Data
(60) Provisional application No. 63/735,588, filed on Dec. 18, 2024.

(51) Int. Cl. G06F 17/16; G06N 5/04

(52) U.S. Cl. CPC G06F 17/16; G06N 5/04

(57) ABSTRACT

An apparatus, comprising a controller; a memory device storing a first matrix associated with a layer of an artificial intelligence (AI) model, the first matrix comprising a zero-valued element having a first position index and a non-zero valued element having a second position index; a feeder circuit configured to change the second position index of the non-zero valued element to the first position index and output a condensed first matrix; and a digital circuit configured to generate an inference of the layer of the AI model based on the condensed first matrix.

### CROSS-REFERENCE TO RELATED APPLICATION(S)

The present application claims priority to and the benefit of U.S. Provisional Application No. 63/735588, filed Dec. 18, 2024, entitled “HW/SW Sparse Computation Solution in A-HBM for Large Context Length LLM Inference,” the content of which is incorporated herein by reference.

### FIELD

One or more aspects of embodiments according to the present disclosure relate to memory devices, and more particularly, to extending memory capacity and bandwidth for memory devices with compute capability.

### BACKGROUND

The use of artificial intelligence (AI) has increased dramatically over the last few years. AI has become commonly used in domains such as image classification, speech recognition, media analytics, heath care, autonomous machines, smart assistants, and the like. Using AI often necessitates the use of large datasets and advanced algorithms and that similarly necessitate efficient and cost-effective data processing solutions.

The above information disclosed in this Background section is only for enhancement of understanding of the background of the present disclosure, and therefore, it may contain information that does not form prior art.

### SUMMARY

One or more embodiments of the present disclosure are directed to an apparatus comprising: a controller; a memory device storing a first matrix associated with a layer of an artificial intelligence (AI) model, the first matrix comprising a zero-valued element having a first position index and a non-zero valued element having a second position index; a feeder circuit configured to change the second position index of the non-zero valued element to the first position index and output a condensed first matrix; and a digital circuit configured to generate an inference of the layer of the AI model based on the condensed first matrix.

In some embodiments, the first position index includes a first column index and a first row index, and the second position index includes a second column index and the first row index.

In some embodiments, the feeder circuit is configured to remove one or more zero-valued elements in a column of the first matrix and reduce one or more respective column indices of one or more non-zeroed elements in the column by a number of the one or more zero-valued elements removed.

In some embodiments, the feeder circuit is configured to duplicate a second non-zero valued element of the condensed first matrix into a position in the condensed first matrix.

In some embodiments, the first position index includes a first column index and a first row index, and the second position index includes the first column index and a second row index.

In some embodiments, the feeder circuit is configured to remove one or more second zero-valued elements in a row of the first matrix and reduce one or more respective row indices of one or more non-zeroed elements in the row by a number of the one or more second zero-valued elements removed.

In some embodiments, changing the second position index of the non-zero valued element to the first position index includes replacing a value of the zero-valued element with a value of the non-zero valued element.

In some embodiments, the apparatus further comprises one or more registers, wherein the feeder circuit is configured to load one or more elements of the condensed first matrix from the memory device to the one or more registers.

In some embodiments, the apparatus further comprises a multiplication circuit configured to generate a product matrix of the first condensed matrix and a second matrix based on the one or more elements in the one or more registers.

In some embodiments, the feeder circuit is configured to generate, based on the condensed first matrix, a schedule for loading the one or more elements of the condensed first matrix into the one or more registers and execution of computations on the one or more elements by the multiplication circuit.

In some embodiments, the digital circuit is configured to receive index data associated with the first matrix; and change at least one of a column index or a row index of an element in the product matrix based on the index data.

In some embodiments, the digital circuit comprises the feeder circuit and the multiplication circuit.

One or more embodiments of the present disclosure are directed to a method comprising: storing, in a memory device, a first matrix associated with a layer of an artificial intelligence (AI) model, the first matrix comprising a zero-valued element having a first position index and a non-zero valued element having a second position index; changing, by a feeder circuit, the second position index of the non-zero valued element to the first position index and outputting, by the feeder circuit, a condensed first matrix; and generating, by a digital circuit, an inference of the layer of the AI model based on the condensed first matrix.

In some embodiments, the first position index includes a first column index and a first row index, and the second position index includes a second column index and the first row index.

In some embodiments, the method further comprises removing, by the feeder circuit, one or more zero-valued elements in a column of the first matrix; and reducing one or more respective column indices of one or more non-zeroed elements in the column by a number of the one or more zero-valued elements removed.

In some embodiments, the first position index includes a first column index and a first row index, and the second position index includes the first column index and a second row index.

In some embodiments, the method further comprises removing, by the feeder circuit, one or more second zero-valued elements in a row of the first matrix and reduce one or more respective row indices of one or more non-zeroed elements in the row by a number of the one or more second zero-valued elements removed.

In some embodiments, the method further comprises generating, by the feeder circuit, a schedule for loading the one or more elements of the condensed first matrix into one or more registers and execution of computations on the one or more elements by a multiplication circuit.

In some embodiments, the method further comprises generating, by a multiplication circuit, a product matrix of the first condensed matrix and a second matrix.

In some embodiments, the method further comprises receiving, by the digital circuit, index data associated with the first matrix; and changing, by the digital circuit, at least one of a column index or a row index of an element in the product matrix based on the index data.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 depicts a block diagram of a computing system according to one or more embodiments of the present disclosure.

FIG. 2 depicts a block diagram of a base die according to one or more embodiments.

FIG. 3 depicts a block diagram of a processing engine of a base die according to one or more embodiments.

FIG. 4 depicts functions of a hardware engine for matrix multiplication between one or more sparce matrices according to one or more embodiments.

FIG. 5 depicts an example conceptual representation of matrix multiplication between two sparce matrices according to one or more embodiments.

FIG. 6 depicts an example conceptual representation of matrix multiplication between two a sparce matrix and a dense matrix according to one or more embodiments.

FIG. 7 depicts an example conceptual representation of matrix multiplication between a dense matrix and a sparse matrix according to one or more embodiments.

FIG. 8 depicts an example conceptual diagram of latency associated with matrix multiplication without and with sparse matrix condensing according to an embodiment of the present disclosure.

FIG. 9 depicts a flow diagram of a process for matrix multiplication according to one or more embodiments of the present disclosure.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

Embodiments of the present disclosure are described below with reference to block diagrams and flow diagrams. Thus, it should be understood that each block of the block diagrams and flow diagrams may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flow diagrams. Accordingly, the block diagrams and flow diagrams support various combinations of embodiments for performing the specified instructions, operations, or steps.

In addition, a feature of embodiments of the present disclosure may be combined or combined with one or more other features, partially or entirely, and may be operated in various ways, and an embodiment may be implemented independently of one or more other embodiments, or in conjunction with the one or more other embodiments.

In general terms, AI models may perform a large number of computations during tasks such as inference. During inference, attention operations may compute weighted associations between tokens using query, key, and value vectors, enabling the AI model to capture contextual relationships across the input sequence. During inference, a prefill phase may be executed in which input tokens are processed prior to generating any output tokens. During the prefill phase of inference, attention operations may be applied across the input sequence to compute contextual relationships between tokens, making attention one of the main contributors to total prefill latency. For example, attention may account for a majority (e.g., 90%) of total prefill latency for large sequences. Attention may include a large amount of matrix multiplication operations and may be compute-bound, in which the performance of attention may be limited by the speed and availability of computational resources such as processors. In some cases, both matrices involved in a matrix multiplication have elements that have non-zero values, or at least a large portion of the elements (e.g., a portion of the elements that satisfies a threshold) have non-zero values. In such cases, element-wise multiplication results in meaningful, non-zero values. However, in some cases, one or both of the matrices involved in the matrix multiplication have a significant amount of elements (e.g., a number of elements that satisfy a threshold) that have values of zero (referred to as zero-valued elements). In such cases, element-wise multiplication of the zero-value elements produces a result of zero. Although the result is zero, the multiplication nonetheless utilizes computational resources and adds to latency of the matrix multiplication.

Embodiments of the present disclosure are directed to systems and methods for reducing the amount of element-wise multiplication between zero-value elements, which may reduce utilization of compute resources and reduce latency associated with such matrix multiplication during AI inference.

In some embodiments, a processor may receive a pair of matrices (e.g., matrix A and matrix B) to be multiplied. The matrices may be weight and activation matrices associated with a layer of a machine learning model. The processor may determine, based on a preset configuration or algorithm, whether matrix A is a dense matrix or a sparse matrix, and whether matrix B is a dense matrix or a sparse matrix. For example, the configuration may define a dense matrix to be a matrix in which at least a threshold percentage (e.g., 50%, 80%, or the like) of the elements in the matrix have non-zero values. The configuration may define a sparse matrix as a matrix in which the percentage of elements having non-zero values is below the threshold. Thus, in some embodiments, a matrix is either a dense matrix or a sparse matrix.

For matrix multiplication operations in which at least one of the matrices is a sparse matrix, the processor may perform a matrix condensing operation on the sparse matrix to transform the sparse matrix into a condensed matrix. In some embodiments, the processor performs column-wise condensing, in which zero-value elements in the sparse matrix are removed and non-zero elements are shifted in a first preset direction (e.g., leftward of a current column of the matrix) to fill one or more empty positions left by the removed elements. The shift of the non-zero elements in the first preset direction may reduce the number of columns of the matrix that contain elements. For example, an empty position (e.g., a position having a zero-value element) in a first (e.g., leftmost) column of a sparse matrix may be filled with the next leftmost non-zero element in the same row as the empty position. In some embodiments, the empty position left by the shifted element is filled with the next non-zero element in that row, until all of the non-zero elements in that row are concentrated towards the left side of the matrix with no empty positions or zero-value elements in between. In some embodiments, the first matrix (e.g., left operand or premultiplier) is subject to column-wise condensing. For example, in the matrix multiplication A×B, matrix A is subject to column-wise condensing.

In some embodiments, the processor is configured to perform row-wise condensing, in which zero-value elements in the sparse matrix are removed and non-zero elements are shifted in a second preset direction (e.g., upward from a current row of the matrix) to fill any empty positions left by the removed elements. The shift of the non-zero elements in the second preset direction may reduce the number of rows of the matrix that contain elements. For example, an empty position (e.g., a position having a zero-value element) in a first (e.g., topmost) row of a sparse matrix may be filled with the next non-zero element in the same column as the empty position. The empty position left by the shifted element may be filled with the next non-zero element in that column, until all of the non-zero elements in that column are concentrated towards the top of the matrix with no empty positions or zero-value elements in between. In some embodiments, the second matrix (e.g., right operand or postmultiplier) is subject to row-wise condensing. For example, in the matrix multiplication A x B, matrix B is subject to row-wise condensing.

In some embodiments, if both matrices in the matrix multiplication are sparse matrices, both matrices are condensed. The processor may schedule fused multiply-add (FMA) operations for the condensed matrices. In some examples in which both matrixes have been condensed, the processor schedules FMA operations starting from the left-most column of the condensed matrix A and the topmost row of matrix B to right-most column of matrix A that has non-zero elements and the bottom-most row of matrix B that has non-zero elements. The processor may execute the FMA operations according to the schedule and output values of the product matrix. In some embodiments, the output values of the product matrix have metadata that indicate the respective positions of the output values in the product matrix. In some embodiments, one or more remaining positions of the product matrix may be filled with zeros.

Embodiments of the present disclosure provide for reducing the amount of element-wise multiplication between zero-value elements that would otherwise be performed and which may take up resources and contribute to latency despite not producing meaningful information. By reducing the amount of element-wise multiplication, utilization of compute resources and latency associated with the matrix multiplication may be reduced during an AI inference process.

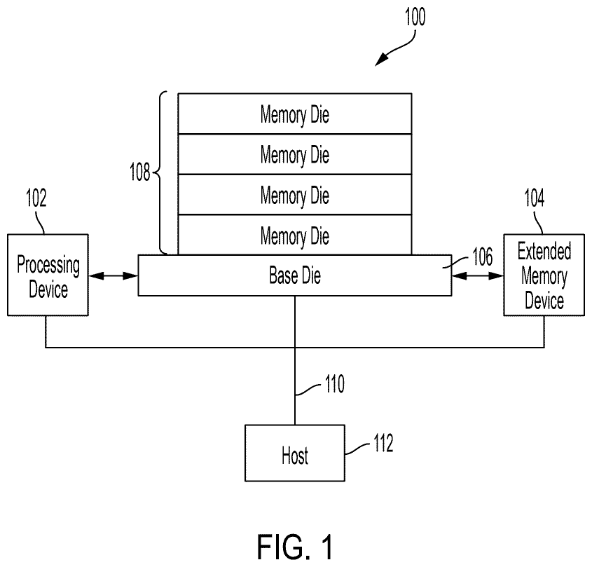

FIG. 1 depicts a block diagram of a computing system for performing aspects of AI computations, according to an embodiment of the present disclosure. The computing system includes a computational memory device 100 coupled to a processing device 102 and an extended memory device 104. In some embodiments, one or more of the computational memory devices 100, processing devices 102, and extended memory devices 104, may be packaged together in a single physical device, such as, for example, in an advanced high bandwidth memory (A-HBM) companion device.

The computational memory device 100 may be, for example, a 3D-stacked memory device (e.g., an HBM) with one or more embedded processing devices (e.g., PIMs). In this regard, the 3D-stacked memory device may include a base die (also referred to as a buffer or logic die) 106, and two or more memory dies (also referred to as core dies or memory stack) 108 stacked over the base die 106. One or more of the processing devices (e.g., PIMs) may be embedded in the one or more memory dies (also referred to as memory stack) 108 and/or in the base die 106.

The memory dies 108 may be implemented as DRAMs. However, the present disclosure is not limited thereto, and the memory dies 108 may be implemented as any suitable memory that may be implemented in a 3D-stacked structure.

In some embodiments, the processing device 102 includes a GPU, although the present disclosure is not limited thereto. For example, the processing device 102 may, in addition or in lieu of the GPU, include neural processing unit (NPU), a tensor processing unit (TPU), co-processor unit, and/or the like. The processing device 102 may be configured to perform computations or operations (used interchangeably herein) of an application running in a host computing device (“host”) 112. The operations may include, for example, prefill and/or decode operations of a large language model (LLM), although the present disclosure is not limited thereto, and may include other computations of the application.

In some embodiments, the extended memory device 104 includes an LPDDR, although embodiments are not limited thereto. For example, the extended memory device 104 may, in lieu or in addition to an LPDDR, include a static DRAM (SDRAM), random access memory (RAM), flash memory, and/or the like. The use of an extended memory device 104 such as an LPDDR may allow the capacity and bandwidth of the computational memory device 100 to be increased in a cost efficient manner.

In some embodiments, the host 112 is coupled to the computational memory device 100, the processing device 102, and the extended memory device 104 over one or more data communication links 110. In some embodiments, communication of the processing device 102 and the extended memory device 104 is through the base die 106. The host 112 may include an external processor such as, for example, a central processing unit (CPU). In some embodiments, the CPU is configured to run one or more applications including AI and/or machine learning applications. The machine learning application may include, for example, an LLM. Computations may be performed while running the application. The computations may be offloaded to the computational memory device 100 and/or processing device 102 for a faster and more efficient computation.

In some embodiments, the computational memory device 100 and/or the processing device 102 receive control instructions from the host 112 through the data communication links 110. The control instructions may be for allocating memory in the computational memory device 100 and/or the extended memory device 104. The control instructions may also be for instructing the computational memory device 100 and/or the processing device 102 to perform operations for an application running in the host 112.

The host device 112 may run an AI application. During training and/or inference by an AI model associated with the AI application, the AI application may transmit a request for linear data transformation (e.g., matrix multiplication) to the computational memory device 100, which may be configured to handle high-throughput linear data transformation (e.g., matrix multiplication). The computational memory device 100 may receive and parse requests from the AI application, load associated data (e.g., matrix data, tensors, etc.) from designated memory locations (e.g., the memory dies 108, the extended memory device 104, etc.), and perform the linear transformation (e.g., matrix multiplication) on the data.

In some embodiments, the computational memory device 100 includes a sparse matrix hardware circuit configured to condense operand matrices for matrix multiplication of the operand matrices. A matrix that is input to the sparse matrix hardware circuit may undergo digital logic processing in which zero-value elements of the matrix are removed and non-zero value elements are shifted leftward or upward to reduce the number of columns or rows of the matrix. This dimensional reduction of the matrix may reduce the number of element-wise operations performed by the computational memory device 100 for a matrix multiplication, to reduce the use of computational resources, reduce power consumption, and reduce latency associated with operation of the computational memory device 100, while maintaining the full data integrity. The computational memory device 100 may transmit the computed results back to the AI application. The application may use the computed results to update model parameters during training or to generate a prediction during inference.

The computational memory device 100 and process according to the various embodiments of the present disclosure may enhance performance and responsiveness across a wide range of AI applications, such as, for example, AI applications in which speed and latency may be a particularly important performance metric. For example, in autonomous vehicle systems, AI tasks such as image classification and object detection may be carried out using deep convolutional neural networks (CNNs) and the like, which perform numerous matrix multiplications across multiple layers to extract and classify features from input images. The computational memory device 100 and techniques of the various embodiments for condensed matrix multiplication may reduce the latency associated with such matrix operations, thus reducing the time it takes to analyze high-resolution visual data and output inferences or predictions related to detected images or objects. This improvement in processing speed may support faster detection of traffic signs, pedestrians, other vehicles, and road features, thereby contributing to improved responsiveness and safety in real-time driving scenarios. For example, the speed in which the matrix multiplications are performed may control the speed in which an autonomous vehicle system is controlled to move to avoid collision or other hazardous situations.

In natural language processing (NLP) applications, such as speech-to-text conversion or real-time translation, transformer-based models may perform a large number of matrix multiplications as part of their attention mechanisms and feedforward layers. The computational memory device 100 and techniques of the various embodiments for condensed matrix multiplication may be employed to accelerate these matrix multiplications, reducing the latency of token prediction and contextual encoding steps. As a result, translation systems may respond more promptly to incoming speech or text, and thus perform more seamlessly to meet the speed of natural conversation.

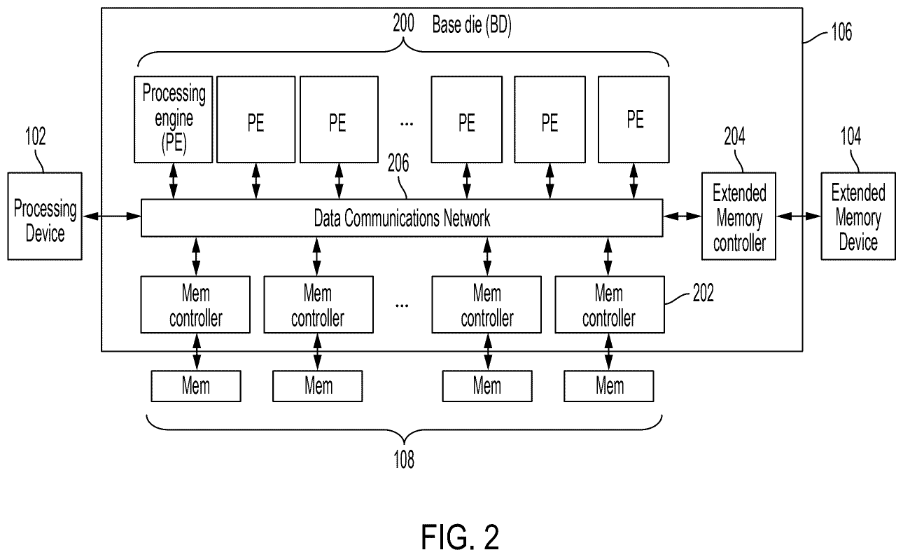

FIG. 2 depicts a block diagram of the base die 106 according to one or more embodiments of the present disclosure. The base die 106 includes one or more processing engine (PE) or devices (also referred to as PIMs) 200, one or more memory controllers 202, and an extended memory controller 204, communicating with each other over a data communications network 206. The data communications network 206 may also enable communication between the processing device 102 and the base die 106 or the extended memory device 104. The communication may be, for example, to allow the processing device 102 to write or read data to or from the memory die 108 and/or extended memory device 104. The data communications network 206 may be implemented, for example, as a network-on-chip (NoC) interconnect.

One or more of the processing engines 200 may include a computing circuit including, for example, arithmetic logic units (ALUs). The computing circuit may be configured to perform computations requested by the application. For example, the ALUs may retrieve data from the memory die 108 or the extended memory device 104 to perform a computation using the data, and may transmit the results of the computation back to the memory die 108 or extended memory device 104 for storing therein.

In some embodiments, the processing device 102 and one or more of the PEs 200 may be independently invoked to access the memory die 108 and/or the extended memory device 104 to perform computations of an application. In this regard, the processing device 102 and the PE 200 (collectively referenced as processing devices 102, 200) may be mixed and matched with the extended memory device 104 and the memory die 108 (collectively referenced as memory devices 104, 108) to effectively provide four computing devices in a single physical device. The four computing devices (also referred to as usage modes) may include: 1) processing device 102+memory die 108; 2) processing device 102+extended memory device 104; 3) PE 200+memory die 108; and 4) PE 200+extended memory device 104. The computing devices may be independently invoked for performing a computation based on instructions from the host 112.

In some embodiments, the application provides instructions that identify the processing device(s) that are to use a memory device. Physical memory may be allocated in the identified memory device and mapped to the logical address in a logical address space. One or more embodiments of the present disclosure allow for data stored in the allocated physical memory to be shared by the processing devices 102, 200.

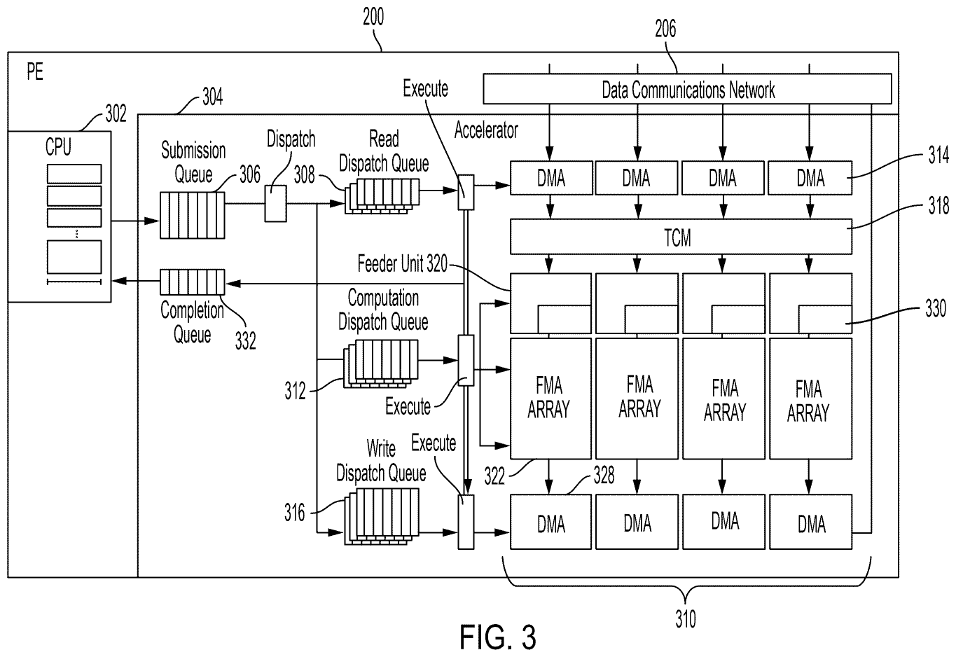

FIG. 3 depicts a block diagram of a processing engine (PE) 200 of a base die 106 according to one or more embodiments. In some embodiments, the PE 200 performs matrix multiplication for AI operations such as inference. The PE 200 may include a CPU 302 and an accelerator 304. In some embodiments, the PE 200 is managed by the CPU 302, which may initiate and orchestrates matrix multiplication operations. For example, the CPU 302 may submit operation descriptors to a submission queue 306 in the accelerator 304. The submission queue 306 may include a hardware-resident buffer configured to store operation descriptors. Operation descriptors may include data units or records that specify the details of a computation task to be performed. Operation descriptors may include information such as operand addresses or locations (e.g., where a matrix resides in memory), data dimensions (e.g., matrix size, tensor shape), operation type (e.g., matrix multiply, accumulate, activation), control flags or parameters (e.g., precision, scheduling info), dependencies or sequencing info (e.g., order of execution).

In some embodiments, the PE 200 includes a read dispatch queue 308, a computation dispatch queue 312, and a write dispatch queue 316. The dispatch queues 308, 312, 316 may include hardware-managed data structures or buffers that receive operational descriptors from the submission queue 306. The dispatch queues 308, 312, 316 may organize and issue operations or commands to respective functional units (e.g., hardware resources) within the PE 200. In some embodiments, the dispatch queues 308, 312, 316 may hold the operations or commands until the receiving functional unit is ready to perform the operation.

In some embodiments, the read dispatch queue 308 may receive operation descriptors from the submission queue 306 and generate read commands for retrieving matrix data (or other types of operands) from memory dies 108. Matrix data may be in tensor form. The read commands may be issued to and serviced by a direct memory access (DMA) engine 314, which transfers data from memory dies 108 (e.g., HBM) to an on-chip tightly coupled memory (TCM) 318 via the data communications network 206. The DMA engine 314 may include address generation and burst transfer logic for efficient block movement of matrix data into the TCM 318. DMA 314 may also be referred to as a read DMA 314.

Matrix data stored in the TCM 318 may be processed by a feeder circuit or unit 320. In some embodiments, the feeder unit 320 receives commands from the computation dispatch queue 312. The feeder unit 320 may include a configuration of hardware logic components that retrieve matrix operand data from the TCM and prepare the matrix operand data for execution by downstream components. In some embodiments, the feeder unit 320 includes a sparse matrix hardware engine 330. The sparse matrix hardware engine 330 may include hardware circuitry configured to condense sparse matrices to reduce the amount of computation associated with matrix multiplication operations involving sparse matrices. The sparse matrix hardware engine 330 may generate a hardware-level execution schedule for loading non-zero operand tiles into compute registers and a computational order for carrying out matrix multiplication operations involving the condensed matrices. In some embodiment, in addition to reducing the number of computations, the selective feeding mechanism may also reduce unnecessary data movement. In some examples, the processing engine 200 may receive data, such as from an application running in the host 112, indicating whether a matrix is a sparse matrix and thus is to be condensed by the sparse matrix hardware engine 330. The data may include indices (e.g., row index and column index) of non-zero value elements of the matrix. In some embodiments, the application may designate whether a matrix is a sparse matrix based on a preset configuration, condition, or algorithm. For example, the application may define a sparse matrix to be a matrix in which at least a threshold percentage (e.g., 20%, 30%, or the like) of the elements in the matrix have values of zero. A matrix that is not a sparse matrix may be referred to as a dense matrix.

The condensed matrix data and execution schedule may be transmitted from the feeder unit 320 to a fused multiply-add (FMA) array 322. FMA array 322 may include computation circuitry that performs matrix multiplication utilizing the condensed matrix data in accordance with the execution schedule. The fused FMA array 322 may receive commands from the computation dispatch queue 312. The fused multiply-add array 322 may perform matrix multiplication operations (e.g., element-wise computations) on the condensed matrix in accordance with the execution schedule. The FMA array 322 may include one or more parallel arithmetic units, such as multiply-accumulate (MAC) arrays or vectorized ALUs, configured to perform computations across the condensed matrix data. The FMA array 322 may include hardware registers and summation circuitry configured to perform intermediate and/or final accumulation of partial results. In some embodiments, the accelerator 304 includes one or more compute pipelines 310. The one or more compute pipelines 310 may process matrix multiplications for different sets of matrices concurrently.

Outputs of the FMA array 322 (e.g., results of the matrix multiplication) may be provided to a write DMA 328 (e.g., DMA router). The write DMA 328 may receive commands from the write dispatch queue 316 to store the results to designated output registers. The write DMA 328 may include logic for selecting accumulated results, generating output memory addresses, and initiating DMA write transactions back to memory 108 or another memory location. These completed tasks may be recorded in a completion queue 332, which may store status tokens indicating the availability of the results and signals task completion to the CPU 302.

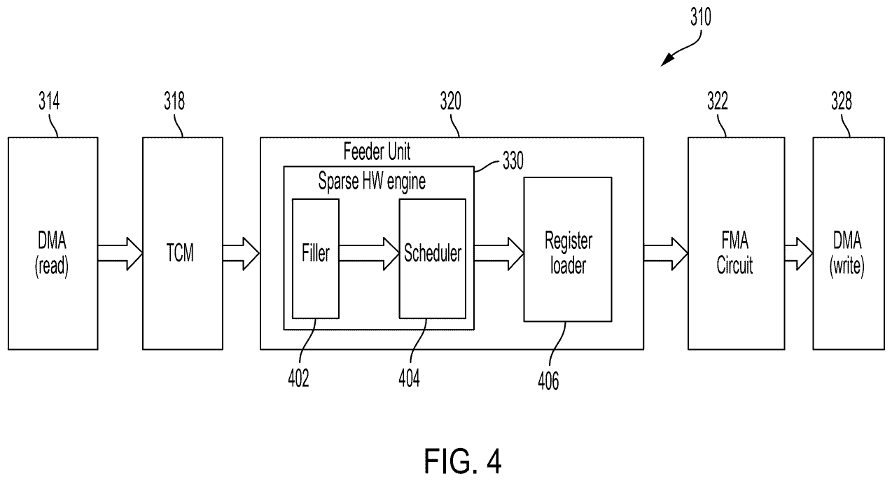

FIG. 4 depicts a block diagram of the compute pipeline 310 for matrix multiplication of one or more sparse matrices according to one or more embodiments. In some embodiments, the compute pipeline 310 includes the read DMA 314, the TCM 318, the feeder unit 320, the FMA array 322, and the write DMA 328. In some embodiments, the feeder unit 320 includes the sparse matrix hardware engine 330 and a register loader 406. The sparse matrix hardware engine 330 may include a filler 402 and a scheduler 404. The filler 402 may include hardware circuitry configured to condense sparse matrices to reduce the amount of computation associated with matrix multiplication operations involving sparse matrices.

The scheduler 404 may generate a hardware-level execution schedule for carrying out the operations of the matrix multiplication. The execution schedule may include address or index information for the operands (e.g., non-zero matrix elements) and an order for loading the operands into compute registers and carrying out FMA operations.

The register loader 406 may receive the execution schedule from the sparse matrix hardware engine and load operand data into compute registers according to the execution schedule for execution by the FMA array 322. The FMA array 322 outputs results of the matrix multiplication performed according to the execution schedule to the write DMA, which writes the results to memory (e.g., the memory die 108).

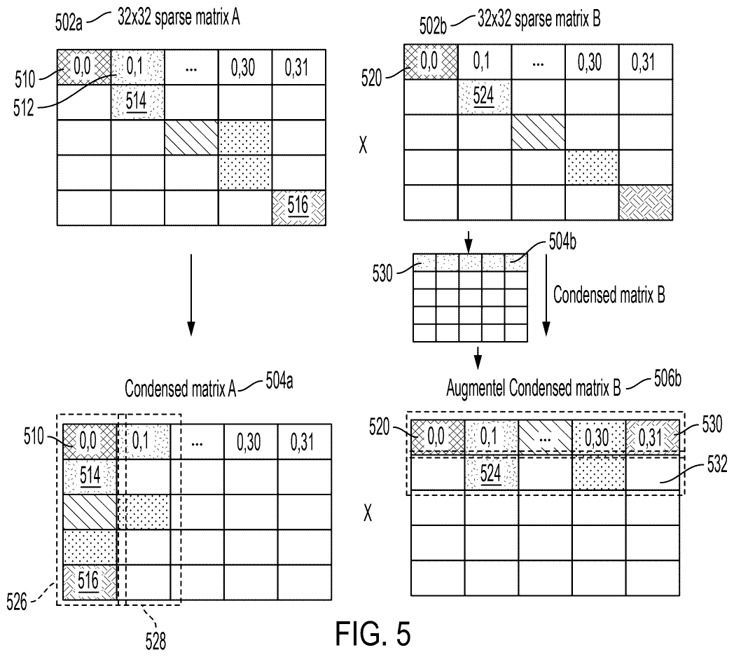

FIG. 5 depicts an example conceptual representation of matrix multiplication between two sparse matrices (e.g., matrix A 502a and matrix B 502b) according to one or more embodiments. The processing engine 200 may receive a first matrix 502a from memory (e.g., the memory die 108, the extended memory 104). The first matrix 502a may refer to a left operand or premultiplier of a matrix multiplication operation. The first matrix 502a may also be referred to as matrix A 502a. In some embodiments, metadata of the first matrix 502a indicates whether the first matrix 502a is a sparse matrix. If the first matrix 502 is designated as a sparse matrix, the first matrix is to be processed by the sparse matrix hardware engine 330 to condense the sparse matrix. In the example of FIG. 5, matrix A is a sparse matrix and processed by the sparse matrix hardware engine 330 to generate a condensed version of matrix A, referred to as condensed matrix A 504a. In some embodiments, the metadata of matrix A 502a includes indices (e.g., row index and column index) of non-zero value elements of the matrix. In FIG. 5, the shaded blocks of matrix A indicate non-zero value elements (e.g., non-zero value elements 510) and the unshaded blocks represent zero value elements (e.g., zero value element 540).

The filler 402 of the sparse matrix hardware engine 330 may perform matrix condensing on the sparse matrix A 502a to transform sparse matrix A 502a into condensed matrix A 504a. In some embodiments, matrix condensing, when applied to a left operand (e.g., premultiplier) such as matrix A 502a, includes column-wise condensing. In some embodiments, the filler 402 carries out hardware logic that performs column-wise condensing on matrix A 502, in which zero-value elements in matrix A 502 are filled with non-zero elements that are shifted in a first preset direction (e.g., leftward of a current column of the non-zero element). For example, in matrix A 502a, non-zero element 510 is already in the leftmost available position of its row. Thus, non-zero element 510 remains in that position in condensed matrix A 504a. Similarly, non-zero element 512 is also already in the leftmost available position of its row and remains in the same position in condensed matrix A 504a. However, non-zero value element 514 is not in the leftmost available position of its row because of zero-value element 540. Thus, non-zero element 514 is shifted to the leftmost available position in its row in condensed matrix A 504a. Zero-value element 540 may be removed.

In some embodiments, a position in a sparse matrix (e. g, matrix A) having zero-value elements that are to the left of any non-zero value elements may be filled with one of the non-zero values such that there are no zero value elements to the left of any non-zero elements, as shown in condensed matrix A 504a. In some embodiments, the shifting of a non-zero element may include assigning the non-zero element a condensed column index reflecting the column the non-zero element is shifted into. For example, non-zero element 516 may originally have a sparse matrix column index of 31 and row index of 31, and a condensed matrix column index of 0 and index of 31. In some embodiments, for a given row of sparse matrix A 502a, the column index of non-zero elements in the row are reduced to the lowest available column index that is not already occupied by another non-zero element. The order of the non-zero elements in the row is retained (e.g., an element having a higher column index than another element in the same row in sparse matrix A 502a still has a higher column index than the other element in condensed matrix A 504a). In this manner, the number of columns having data may be reduced, potentially reducing the number of compute cycles used to multiply the matrix.

In the example depicted in FIG. 5, matrix A 502a is to be multiplied with a matrix B 502b, which is also a sparse matrix. In this example, matrix B 502b is the right operand (e.g., postmultiplier) in the matrix multiplication. The filler 402 of the sparse matrix hardware engine 330 may perform matrix condensing on the sparse matrix B 502b to transform sparse matrix B 502b into condensed matrix B 504b. In some embodiments, matrix condensing, when applied to a right operand (e.g., postmultiplier) such as matrix B 502b, includes row-wise condensing. In some embodiments, the filler 402 carries out hardware logic that performs row-wise condensing on matrix B 502b, in which positions in matrix B 502b that have zero-value elements are filled with non-zero elements that are shifted in a first preset direction (e.g., upward of a current row of the non-zero element). For example, in matrix B 502b, non-zero element 520 is already in the upmost available position of its column. Thus, non-zero element 520 remains in that position in condensed matrix B 504b. However, non-zero element 524 is not in the upmost available position of its column. There is one available position upward of non-zero element 524's current position. Thus, non-zero element 524 is shifted to the upmost available position in its column in condensed matrix B 504b.

In some embodiments, a position in a sparse matrix (e.g., matrix B) having a zero-value element that is above any non-zero value elements may be filled with one of the non-zero values such that there are no zero-value elements above any non-zero elements, as shown in condensed matrix B 504b. In some embodiments, the shifting of a non-zero element may include assigning the non-zero element a condensed row index reflecting the row the non-zero element is shifted into. For example, non-zero element 524 may originally have a sparse matrix column index of 1 and row index of 1, and a condensed matrix column index of 1 and row index of 0. In some embodiments, for a given column of sparse matrix B 502b, the row index of non-zero elements in the column are reduced to the lowest available row index that is not already occupied by another non-zero element. The order of the non-zero elements in the column is retained (e.g., an element having a higher row index than another element in the same column in sparse matrix B 502b still has a higher row index than the other element in condensed matrix B 504b). In this manner, the number of rows having data may be reduced, potentially reducing the number of compute cycles used to multiply the matrix.

In some embodiments, the dimensions of the two condensed matrices that are to be multiplied may not be compatible. For example, condensed matrix A 504a has 2 columns (e.g., first column 526 and second column 528) and condensed matrix B 504b has 1 row (e.g., first row 530). In order to enable matrix multiplication between condensed matrix A 504a and condensed matrix B 504b, condensed matrix B 504b is augmented with a second row 532 to generate an augmented condensed matrix B 506b that has a compatible number of row (e.g., 2 rows). For example, individual values from the first row 530 of condensed matrix B 504b may be duplicated into column positions in the second row 532 that correspond to the output columns in a resulting product matrix where contributions from non-zero elements in the second column 528 of condensed matrix A 504a are expected, thereby aligning the rows of augmented condensed matrix B 506b with the columns of condensed matrix A that contain non-zero elements for valid and complete matrix multiplication.

Matrix multiplication may be performed on condensed matrix A 504a and augmented condensed matrix B 506b. If condensed matrix B 504b has the appropriate number of rows and augmentation was not needed, then matrix multiplication can be performed on condensed matrix B 504b. In some embodiments, matrix multiplication operations may be performed based on an execution schedule generated by the scheduler 404 of the sparse matrix hardware engine 330. For example, the scheduler 404 schedules matrix multiplication operations from the left-most column to the right-most column of condensed matrix A 504a and load corresponding non-zero elements from TCM 318 to registers in the FMA array 322.

In some embodiments, because the non-zero elements of condensed matrix A 504a and augmented condensed matrix B 506b were moved from their original positions, the elements in the resulting product matrix of the matrix multiplication may not be in the correct positions. In some embodiments, the original indices and condensed indices of the elements were recorded as metadata. The correct positions (e.g., indices) of the elements in the resulting product matrix may be determined and provided as metadata. Thus, the true result of the matrix multiplication of original (e.g., sparse) matrix A 502a and original (e.g., sparse) matrix B 502b can be reconstructed based on these indices.

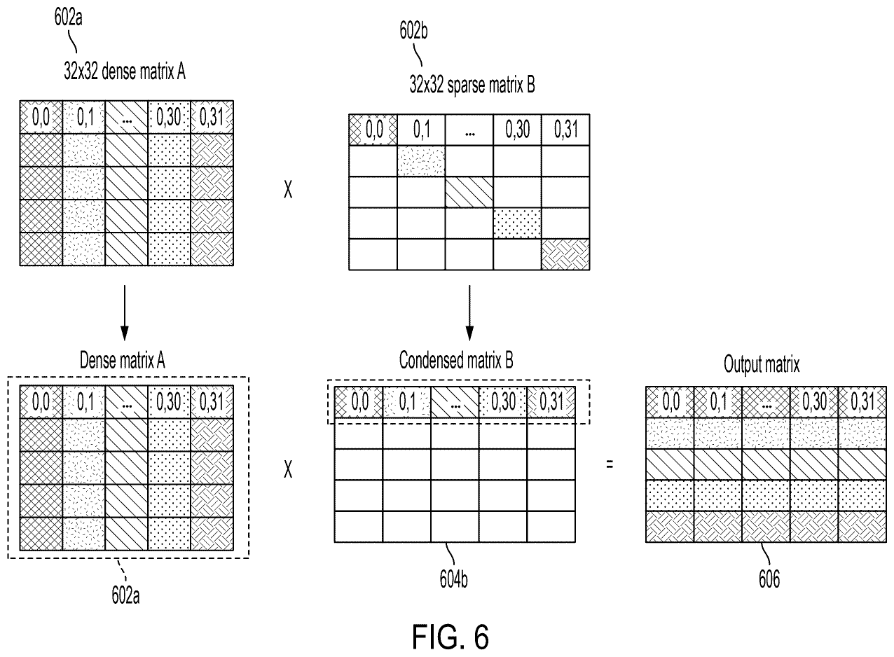

FIG. 6 depicts an example conceptual representation of matrix multiplication between a sparse matrix and a dense matrix according to one or more embodiments. In this example, matrix A 602a is a dense matrix and matrix B 602b is a sparse matrix. In some embodiments, dense matrices are not condensed by the sparse matrix hardware engine 330 and used (e.g., multiplied) as is. Sparse matrix B 602b, being a right operand in this example, may undergo the row-condensing operations described above with respect to sparse matrix B 502b of FIG. 5. The sparse matrix hardware engine 330 may generate a condensed matrix B 604b from sparse matrix B 602b. Dense matrix A 602a and condensed matrix B 602b may be multiplied in the FMA array 322 to generate an output matrix 606.

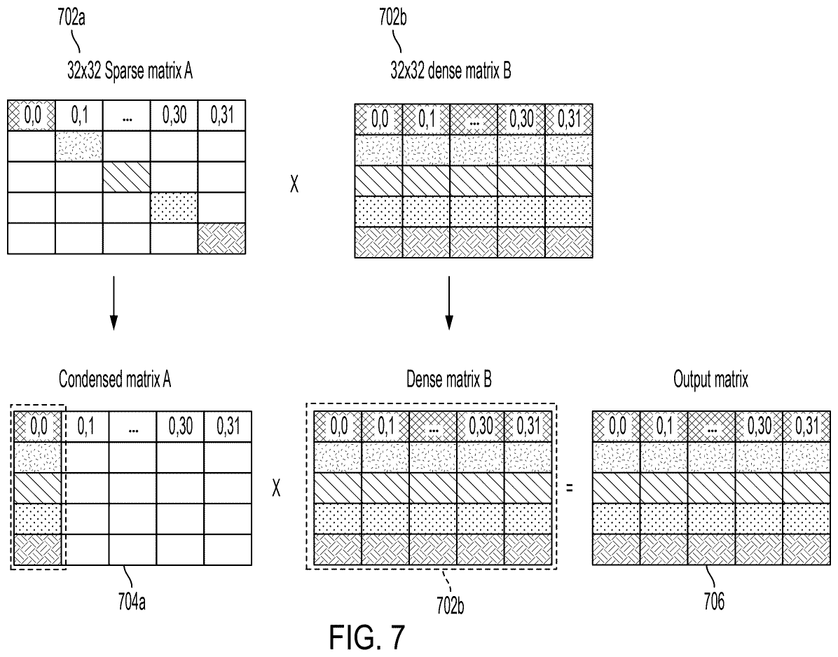

FIG. 7 depicts an example conceptual representation of matrix multiplication between a dense matrix and a sparse matrix according to one or more embodiments. In this example, matrix A 702a is a sparse matrix and matrix B 702b is a dense matrix. Sparse matrix A 702a, being a left operand, may undergo the column-condensing operations described above with respect to sparse matrix A 502a of FIG. 5. The sparse matrix hardware engine 330 may generate a condensed matrix A 704a from sparse matrix A 702b. Dense matrix B 702b may remain as is. Condensed matrix A 704a and dense matrix B 702b may be multiplied in the FMA array 322 to generate an output matrix 706.

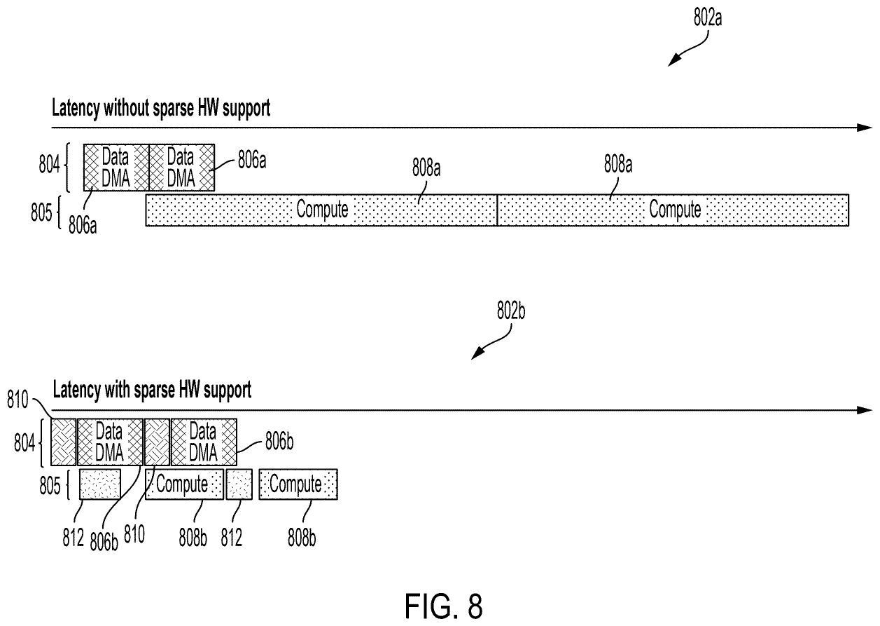

FIG. 8 depicts an example conceptual diagram comparing a latency timeline 802a for matrix multiplication of sparse matrices without the sparse matrix hardware engine 330 and a latency timeline 802b for matrix multiplication of sparse matrices with the sparse matrix hardware engine 330 and matrix condensing. The latency timelines 802 respectively show a memory latency 804 and a compute latency 805. In some examples, a data DMA latency 806a without matrix condensing may be generally similar to data a DMA latency 806b with matrix condensing, as all elements of the matrices may be loaded in both cases. In some embodiments, there may be metadata DMA associated with matrix condensing for loading indices of non-zero elements of the matrices, which adds to the memory latency 805 of the latency timeline 802b for matrix multiplication with matrix condensing. In some embodiments, there may also be a filling latency 812 for filling positions with non-zero elements, which adds to the compute latency 805 of the latency timeline 802b for matrix multiplication with matrix condensing. However, a compute latency 808b of matrix multiplication with matrix condensing may be significantly shorter than a compute latency 808a without matrix condensing, as there may be fewer computations when sparse matrices are condensed. Since matrix multiplication is generally compute bound, reducing the compute latency 808b may reduce the overall latency of the operation, and added memory latency due to metadata DMA 810 may be hidden by the compute latency 808b.

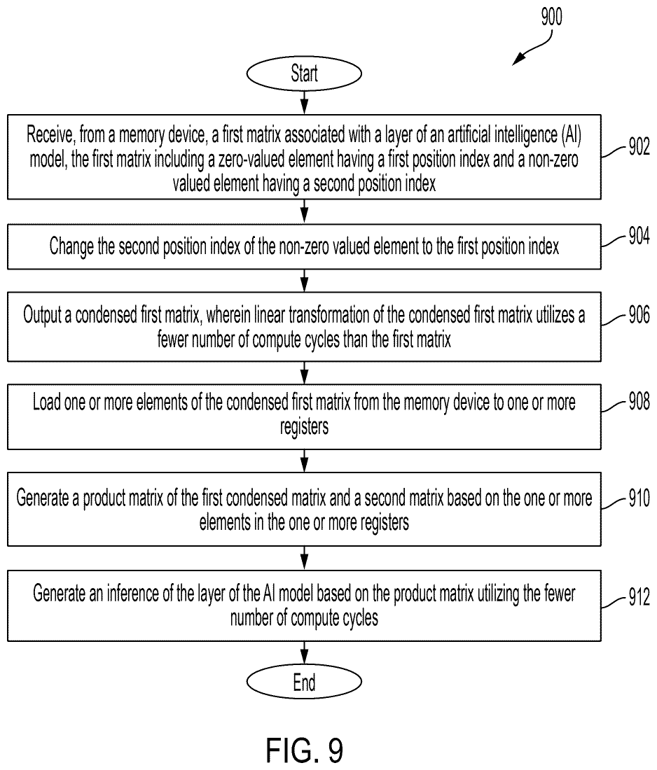

FIG. 9 depicts a flow diagram of a process for matrix multiplication according to one or more embodiments of the present disclosure.

At operation 902, a digital circuit such as that of a processing engine 200 may receive a first matrix (e.g., sparse matrix A 502a) from a memory device (e.g., memory die 108, extended memory device 104, and the like). The first matrix may be associated with a layer of an artificial intelligence (AI) model. In some embodiments, the first matrix includes a zero-valued element having a first position index (e.g., 1,0) and a non-zero valued element having a second position index (e.g., 1,1). In some embodiments, the first position index includes a first column index (e.g., 0) and a first row index (e.g., 1), and the second position index includes a second column index (e.g., 1) and the first row index (e.g., 1). In some embodiments, the first position index includes a first column index (e.g., 1) and a first row index (e.g., 0), and the second position index includes the first column index (e.g., 1) and a second row index (e.g., 1).

At operation 904, a feeder circuit (e.g., feeder unit 320) may change the second position index of the non-zero valued element to the first position index of the zero-valued element. For example, the non-zero valued element may replace the zero-valued element. In some examples, changing the second position index of the non-zero valued element to the first position index includes replacing a value of the zero-valued element with a value of the non-zero valued element. In some examples, a sparse matrix hardware engine 330, which may be implemented as digital circuity in the feeder unit 320, may change the position of the second position index of the non-zero valued element to the first position index of the zero-valued element.

At operation 906, the feeder circuit (e.g., feeder unit 320) may output a condensed first matrix (e.g., condensed matrix A 504a). In some embodiments, the condensed first matrix includes fewer columns or rows than the first matrix (e.g., sparse matrix A 502a). In some embodiments, a linear transformation (e.g., matrix multiplication) of the condensed first matrix (e.g., condensed matrix A 504a) utilizes a fewer number of compute cycles than the first matrix (e.g., sparse matrix A 502a). Thus, the linear transformation may be performed with decreased power consumption and increased speed. In some embodiments, such as when the condensed first matrix is a left operand of a matrix multiplication operation, the feeder circuit (e.g., feeder unit 320) is configured to remove one or more zero-valued elements in a column of the first matrix and reduce one or more respective column indices of one or more non-zeroed elements in the column by the number of zero-valued elements removed. In some embodiments, such as when the condensed first matrix is a right operand of a matrix multiplication operation, the feeder circuit is configured to remove one or more second zero-valued elements in a row of the first matrix and reduce one or more respective row indices of one or more non-zeroed elements in the row by the number of second zero-valued elements removed.

At operation 908, the feeder circuit (e.g., feeder unit 320) may load one or more elements of the condensed first matrix from the memory device to one or more registers of the processing engine 200. In some embodiments, the feeder circuit is configured to generate a schedule for executing data loading and computing based on the condensed first matrix. The schedule may include and order and/or timing for loading the one or more elements of the condensed first matrix into the one or more registers. The schedule may include an order and/or timing for execution of computations on the one or more elements by a multiplication circuit such as a multiply-accumulate (MAC) circuit. The multiplication circuit may be implemented as a part of the FMA array 322.

At operation 910, the multiplication (e.g., MAC) circuit may generate a product matrix of the first condensed matrix and a second matrix based on the one or more elements in the one or more registers. In some embodiments, the condensed first matrix includes n number of columns and the second matrix includes at least n+1 number of rows. Thus, to transform the first condensed matrix into a format that is compatible for matrix multiplication with the second matrix, the feeder circuit (e.g., feeder unit 320) may duplicate a second non-zero valued element of the condensed first matrix into a position in the condensed first matrix having a column index of n+1. The second non-zero valued element may be the same element as the first non-zero valued element or a different element.

At operation 912, the digital circuit (e.g., processing engine 200) generates an inference of the layer of the AI model based on the product matrix utilizing the fewer number of compute cycles. In this manner, the digital circuit (e.g., processing engine 200) is able to perform AI inference with decreased power consumption and increased speed.

As a person of skill in the art should appreciate, embodiments of the present disclosure allow for increased transactions to be processed via, for example, the concurrent usage modes, when compared to a solution that uses a single processing device (e.g., a GPU server). The usage modes may be invoked to handle different operations (e.g., prefill operations and decode operations) concurrently using a shared physical memory space. Although two GPU servers may achieve similar increased transactions, the use of two GPU servers may be more expensive in terms of power and money than embodiments of the present disclosure. Embodiments of the present disclosure also provide flexibility in the mix and matching of processing devices and memory devices based on the operations to be performed.

One or more embodiments of the present disclosure may be implemented in one or more processors or processing devices. The term processor or processing device may refer to one or more processors and/or one or more processing cores. The one or more processors may be hosted in a single device or distributed over multiple devices (e.g. over a cloud system). A processor may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processor, as used herein, each function is performed either by hardware configured, i.e., hard-wired, to perform that function, or by more general-purpose hardware, such as a CPU, configured to execute instructions stored in a non-transitory storage medium (e.g. memory). A processor may be fabricated on a single printed circuit board (PCB) or distributed over several interconnected PCBs. A processor may contain other processing circuits; for example, a processing circuit may include two processing circuits, an FPGA and a CPU, interconnected on a PCB.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. Also, unless explicitly stated, the embodiments described herein are not mutually exclusive. Aspects of the embodiments described herein may be combined in some implementations.

As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

Although exemplary embodiments of systems and methods for extended memory capacity and bandwidth have been specifically described and illustrated herein, many modifications and variations will be apparent to those skilled in the art. Accordingly, it is to be understood that systems and methods for extended memory capacity and bandwidth constructed according to principles of this disclosure may be embodied other than as specifically described herein. The disclosure is also defined in the following claims, and equivalents thereof.

The systems and methods for extending memory capacity and bandwidth may contain one or more combination of features set forth in the below statements.
Statement 1: An apparatus, comprising: a controller; a memory device storing a first matrix associated with a layer of an artificial intelligence (AI) model, the first matrix comprising a zero-valued element having a first position index and a non-zero valued element having a second position index; a feeder circuit configured to change the second position index of the non-zero valued element to the first position index and output a condensed first matrix; and a digital circuit configured to generate an inference of the layer of the AI model based on the condensed first matrix.
Statement 2: The apparatus of statement 1, wherein the first position index includes a first column index and a first row index, and the second position index includes a second column index and the first row index.
Statement 3: The apparatus of statement 1 or 2, wherein the feeder circuit is configured to remove one or more zero-valued elements in a column of the first matrix and reduce one or more respective column indices of one or more non-zeroed elements in the column by a number of the one or more zero-valued elements removed.
Statement 4: The apparatus of any of statements 1-3, wherein the feeder circuit is configured to duplicate a second non-zero valued element of the condensed first matrix into a position in the condensed first matrix.
Statement 5: The apparatus of any of statements 1-4, wherein the first position index includes a first column index and a first row index, and the second position index includes the first column index and a second row index.
Statement 6: The apparatus of any of statements 1-5, wherein the feeder circuit is configured to remove one or more second zero-valued elements in a row of the first matrix and reduce one or more respective row indices of one or more non-zeroed elements in the row by a number of the one or more second zero-valued elements removed.
Statement 7: The apparatus of any of statements 1-6, wherein changing the second position index of the non-zero valued element to the first position index includes replacing a value of the zero-valued element with a value of the non-zero valued element.
Statement 8: The apparatus of any of statements 1-7, further comprising one or more registers, wherein the feeder circuit is configured to load one or more elements of the condensed first matrix from the memory device to the one or more registers.
Statement 9: The apparatus of any of statements 1-8, further comprising a multiplication circuit configured to generate a product matrix of the first condensed matrix and a second matrix based on the one or more elements in the one or more registers.
Statement 10: The apparatus of any of statements 1-9, wherein the feeder circuit is configured to generate, based on the condensed first matrix, a schedule for loading the one or more elements of the condensed first matrix into the one or more registers and execution of computations on the one or more elements by the multiplication circuit.
Statement 11: The apparatus of any of statements 1-10, wherein the digital circuit is configured to receive index data associated with the first matrix; and change at least one of a column index or a row index of an element in the product matrix based on the index data.
Statement 12: The apparatus of any of statements 1-11, wherein the digital circuit comprises the feeder circuit and the multiplication circuit.
Statement 13: A method, comprising: storing, in a memory device, a first matrix associated with a layer of an artificial intelligence (AI) model, the first matrix comprising a zero-valued element having a first position index and a non-zero valued element having a second position index; changing, by a feeder circuit, the second position index of the non-zero valued element to the first position index and outputting, by the feeder circuit, a condensed first matrix; and generating, by a digital circuit, an inference of the layer of the AI model based on the condensed first matrix.
Statement 14: The method of statement 13, wherein the first position index includes a first column index and a first row index, and the second position index includes a second column index and the first row index.
Statement 15: The method of statement 13 or 14, further comprising: removing, by the feeder circuit, one or more zero-valued elements in a column of the first matrix; and reducing one or more respective column indices of one or more non-zeroed elements in the column by a number of the one or more zero-valued elements removed.
Statement 16: The method of any of statements 13-15, wherein the first position index includes a first column index and a first row index, and the second position index includes the first column index and a second row index.
Statement 17: The method of any of statements 13-16, further comprising: removing, by the feeder circuit, one or more second zero-valued elements in a row of the first matrix and reduce one or more respective row indices of one or more non-zeroed elements in the row by a number of the one or more second zero-valued elements removed.
Statement 18: The method of any of statements 13-17, further comprising: generating, by the feeder circuit, a schedule for loading the one or more elements of the condensed first matrix into one or more registers and execution of computations on the one or more elements by a multiplication circuit.
Statement 19: The method of any of statements 13-18, further comprising: generating, by a multiplication circuit, a product matrix of the first condensed matrix and a second matrix.
Statement 20: The method of any of statements 13-19, further comprising: receiving, by the digital circuit, index data associated with the first matrix; and changing, by the digital circuit, at least one of a column index or a row index of an element in the product matrix based on the index data.

What is claimed is:

1. An apparatus, comprising:
a controller;
a memory device storing a first matrix associated with a layer of an artificial intelligence (AI) model, the first matrix comprising a zero-valued element having a first position index and a non-zero valued element having a second position index;
a feeder circuit configured to change the second position index of the non-zero valued element to the first position index and output a condensed first matrix; and
a digital circuit configured to generate an inference of the layer of the AI model based on the condensed first matrix.

2. The apparatus of claim 1, wherein the first position index includes a first column index and a first row index, and the second position index includes a second column index and the first row index.

3. The apparatus of claim 2, wherein the feeder circuit is configured to remove one or more zero-valued elements in a column of the first matrix and reduce one or more respective column indices of one or more non-zeroed elements in the column by a number of the one or more zero-valued elements removed.

4. The apparatus of claim 2, wherein the feeder circuit is configured to duplicate a second non-zero valued element of the condensed first matrix into a position in the condensed first matrix.

5. The apparatus of claim 1, wherein the first position index includes a first column index and a first row index, and the second position index includes the first column index and a second row index.

6. The apparatus of claim 5, wherein the feeder circuit is configured to remove one or more second zero-valued elements in a row of the first matrix and reduce one or more respective row indices of one or more non-zeroed elements in the row by a number of the one or more second zero-valued elements removed.

7. The apparatus of claim 1, wherein changing the second position index of the non-zero valued element to the first position index includes replacing a value of the zero-valued element with a value of the non-zero valued element.

8. The apparatus of claim 1, further comprising one or more registers, wherein the feeder circuit is configured to load one or more elements of the condensed first matrix from the memory device to the one or more registers.

9. The apparatus of claim 8, further comprising a multiplication circuit configured to generate a product matrix of the first condensed matrix and a second matrix based on the one or more elements in the one or more registers.

10. The apparatus of claim 9, wherein the feeder circuit is configured to generate, based on the condensed first matrix, a schedule for loading the one or more elements of the condensed first matrix into the one or more registers and execution of computations on the one or more elements by the multiplication circuit.

11. The apparatus of claim 9, wherein the digital circuit is configured to receive index data associated with the first matrix; and change at least one of a column index or a row index of an element in the product matrix based on the index data.

12. The apparatus of claim 9, wherein the digital circuit comprises the feeder circuit and the multiplication circuit.

13. A method, comprising:
storing, in a memory device, a first matrix associated with a layer of an artificial intelligence (AI) model, the first matrix comprising a zero-valued element having a first position index and a non-zero valued element having a second position index;
changing, by a feeder circuit, the second position index of the non-zero valued element to the first position index and
outputting, by the feeder circuit, a condensed first matrix; and
generating, by a digital circuit, an inference of the layer of the AI model based on the condensed first matrix.

14. The method of claim 13, wherein the first position index includes a first column index and a first row index, and the second position index includes a second column index and the first row index.

15. The method of claim 14, further comprising:
removing, by the feeder circuit, one or more zero-valued elements in a column of the first matrix; and
reducing one or more respective column indices of one or more non-zeroed elements in the column by a number of the one or more zero-valued elements removed.

16. The method of claim 13, wherein the first position index includes a first column index and a first row index, and the second position index includes the first column index and a second row index.

17. The method of claim 16, further comprising:
removing, by the feeder circuit, one or more second zero-valued elements in a row of the first matrix and reduce one or more respective row indices of one or more non-zeroed elements in the row by a number of the one or more second zero-valued elements removed.

18. The method of claim 13, further comprising:
generating, by the feeder circuit, a schedule for loading the one or more elements of the condensed first matrix into one or more registers and execution of computations on the one or more elements by a multiplication circuit.

19. The method of claim 13, further comprising:
generating, by a multiplication circuit, a product matrix of the first condensed matrix and a second matrix.

20. The method of claim 19, further comprising:
receiving, by the digital circuit, index data associated with the first matrix; and
changing, by the digital circuit, at least one of a column index or a row index of an element in the product matrix based on the index data.
